(19) United States
(12) Patent Application Publication
(10) Pub. No.: US 2025/0030145 A1
(43) Pub. Date: Jan. 23, 2025

(54) METHOD FOR MANUFACTURING A WAVEGUIDE DEVICE BY ADDITIVE MANUFACTURING AND POLISHING

(71) Applicant: SWISSto12 SA, Renens (VD) (CH)

(72) Inventors: Emile de Rijk, Grand-Saconnex (CH); Mathieu Billod, Présilly (FR); Philippe Blanc, Bercher (CH)

(21) Appl. No.: 18/717,844

(22) PCT Filed: Dec. 7, 2022
(86) PCT No.: PCT/IB2022/061877

§ 371 Date: Jun. 7, 2024

(30) Foreign Application Priority Data
Dec. 8, 2021 (FR) FR2113174

(51) Int. Cl. H01P 11/00; B22F 10/28; B22F 10/62; B22F 10/80; B33Y 10/00; B33Y 40/20; B33Y 50/00; B33Y 80/00; C23F 3/03; C23F 3/06; H01P 3/12

(52) U.S. Cl. CPC H01P 11/002; B22F 10/28; B22F 10/62; B22F 10/80; B33Y 10/00; B33Y 40/20; B33Y 50/00; B33Y 80/00; C23F 3/03; C23F 3/06; H01P 3/12; B22F 2301/052; B22F 2998/10

(57) ABSTRACT

The invention relates to a method of manufacturing a waveguide device including a step of producing, by additive manufacturing, a semi-finished metal core having side walls having external and internal surfaces, the internal surfaces defining an internal waveguide opening. The manufacturing process further includes a step of chemically polishing the metal core to reduce the thickness of the side walls by an ablation thickness equal to at least twice a roughness of the metal core before polishing, to obtain the waveguide device. The invention also includes a waveguide device obtained according to the above-mentioned process.

### TECHNICAL AREA

The present invention relates to a manufacturing process of a waveguide device by additive manufacturing and polishing, and to a waveguide manufactured according to this process.

### BACKGROUND ART

Radiofrequency (RF) signals can propagate either in space or in waveguide devices. These waveguide devices are used to channel RF signals or to manipulate them in the spatial or frequency domain.

The present invention relates in particular to passive RF devices that enable radiofrequency signals to be propagated and manipulated without the use of active electronic components. Passive waveguide devices can be divided into three distinct categories:
Devices based on guiding waves inside hollow metal channels, commonly known as waveguides.
Devices based on waveguiding inside dielectric substrates.
Devices based on waveguiding by means of surface waves on metal substrates such as PCBs, microstrips, etc.

The present invention relates in particular to the manufacture of waveguide devices according to the first category above, hereinafter collectively referred to as waveguide devices. Examples of such devices include waveguides as such, filters, antennas, polarizers, mode converters and so on. They can be used for signal routing, frequency filtering, signal separation or recombination, transmission or reception of signals in or from free space, etc.

Conventional waveguides are hollow devices whose shape and proportions determine the propagation characteristics for a given wavelength of electromagnetic signal. Conventional waveguides used for radiofrequency signals have internal openings of rectangular or circular cross-section. They can propagate electromagnetic modes corresponding to different electromagnetic field distributions along their cross-section.

Manufacturing waveguides with complex cross-sections is difficult and costly. To remedy this, patent application US2012/0084968 proposes to produce waveguides by 3D printing. To this end, a non-conductive plastic core is printed using an additive method and then covered with a metal plating by immersion. The internal surfaces of the waveguide must indeed be electrically conductive in order to operate. The use of a non-conductive core not only allows to reduce the weight and cost of the device, but also enables 3D printing methods suitable for polymers or ceramics to be used, making it possible to produce high-precision parts with low wall roughness. The parts described in this document have complex shapes and include, on the one hand, a channel for wave propagation and, on the other hand, holes for attachment to a foot of the waveguide, in order to secure it to another element.

Various 3D printing techniques exist, including selective laser melting (SLM) 3D printing. This is a selective powder-bed melting process in which a laser is used to fuse fine metal particles. Following a computer-determined pattern, it melts the metal particles until they fuse together. A powder spreading system then applies a new layer of powder. The laser then draws the next layer. These steps follow one another until the object is fully printed.

Although SLM printing can print layer thicknesses ranging from 0.02 mm to 0.10 mm on the Z axis, resolution on the X and Y axes depends on the diameter of the machine's laser beam. Standard SLM machines use lasers with diameters of 0.080 mm and 0.1 mm. The molten pool around the laser beam for aluminum has a diameter of around 0.250 mm. Ideally, a minimum of 2 vectors is required to produce a waveguide wall, hence a minimum thickness of 0.5 mm.

Depending on the desired shape, the metal parts obtained by this process can have layer thicknesses well beyond the Z resolution of the machine, which are imposed by the above-mentioned constraints. This has a direct impact on the weight of the parts produced.

3D printing by selective laser sintering (SLS) is also well known, particularly for plastic printing. However, it presents the same problems of resolution, linked in particular to the diameter of the laser beam.

Document PETRONILO MARTIN-IGLESIAS ET AL: “Additive Manufacturing for RF Passive Hardware”, 46TH EUROPEAN MICROWAVE CONFERENCE, 4-6 Oct. 2016, LONDON, UK, pages 1-174 discloses the use of a chemical polishing process in waveguide devices obtained by additive manufacturing. However, this document mentions in particular that this chemical polishing process has numerous disadvantages such as iris enlargement and its inhomogeneous effect, the fact that it is only used for narrow-band filters, slowness as well as frequency center shift or the difficulty of predicting its effect.

Document LORENTE J A ET AL: “Single part microwave 1-5,17 filters made from selective laser melting”, MICROWAVE CONFERENCE, 2009. EUMC 2009. EUROPEAN, IEEE, PISCATAWAY, NJ, USA, Sep. 29, 2009 (2009-09-29), pages 1421-1424 discloses a chemical polishing process, but does not address the issue of wall thickness or the weight of polished devices.

The paper ALI USMAN ET AL: “Internal surface roughness enhancement of parts made by laser powder-bed fusion additive manufacturing”, VACUUM, PERGAMON PRESS, GB, vol. 177, Apr. 22, 2020 (2020-04-22), also discloses a process for chemical polishing of parts produced by laser powder-bed fusion. However, the wall thicknesses of the parts envisaged are relatively large (and therefore heavy) and do not correspond to the standard of modern RF parts obtained by additive manufacturing.

Document CN106757039B discloses an aluminum oxide-based chemical polishing liquid and a method for its manufacture. The use of this liquid for polishing RF components is not mentioned. Furthermore, the liquid appears to be intended to improve the aesthetic appearance of polished parts.

Document GB2575365A discloses a process for chemical polishing of a titanium surface obtained by additive manufacturing. A use for RF devices is not disclosed.

### BRIEF SUMMARY OF THE INVENTION

One aim of the present invention is therefore to provide an SLM-type additive manufacturing process for producing a lighter waveguide device.

In particular, one aim of the present invention is to enable the manufacture of a metal or plastic waveguide device which has a thickness of less than 0.5 mm over any portion of the device, and preferably less than 0.3 mm, or even less than 0.2 mm.

According to the invention, these aims are achieved in particular by means of a process for manufacturing a waveguide device comprising a step consisting in producing, by additive manufacturing, a semi-finished metal or plastic core. The semi-finished core has side walls with external and internal surfaces. The internal surfaces define a waveguide channel. The manufacturing process further comprises a step of chemical polishing of the metal core in order to reduce, preferably uniformly, the thickness of said side walls by an ablation thickness equal to at least twice a roughness of the metal core (2) before polishing, in order to obtain the waveguide device.

In one embodiment, the ablation thickness is at least 0.02 mm, preferably at least 0.05 mm.

In one embodiment, the ablation thickness is greater than an additive printing layer thickness.

In one embodiment, the metal core is produced by laser melting on powder bed (SLM) additive manufacturing to obtain a semi-finished metal core, and the ablation thickness is at least 1.5 times a powder grain size of said powder bed.

In one embodiment, the metal core is produced by additive manufacturing using laser melting on a powder bed (SLM) to obtain a semi-finished metal core, the thickness of the laser spot used for melting has a diameter of between 0.03 mm and 0.1 mm and the ablation thickness is between 0.02 mm and 0.06 mm.

In one embodiment, the metal core is produced by additive manufacturing using laser melting on a powder bed to obtain a semi-finished metal core with a thickness of the side walls equal to or less than 0.5 mm.

In one embodiment, the internal waveguide opening of the semi-finished metal core has an oblong, hexagonal, pentagonal, ovoid or circular cross-section.

In one embodiment, the thickness of said side walls is less than 0.3 mm, or even less than 0.2 mm after the chemical polishing step.

In one embodiment, the manufacturing process further comprises in step of generating a digital model of the metal core. The digital model is calculated in order to optimize the shape of the semi-finished metal core as a function of the thickness to be removed by chemical polishing.

In one embodiment, the chemical polishing step consists in immersing the semi-finished metal core in an acid bath. The acid bath may comprise a mix of two acids. For example, the acid bath may comprise orthophosphoric acid and sulfuric acid, to obtain a brightening effect.

In one embodiment, the chemical polishing step consists of immersing the semi-finished metal core in a basic bath, for example to perform satin-finishing. The basic bath may comprise a caustic solution and have a pH greater than 11.5.

In one embodiment, a step of immersing the metal core in an acidic deoxidation bath following immersion in said basic bath, in order to remove oxidized residues from the surface of the parts.

In one embodiment, the process may comprise a step of immersing the metal core in an acid bath, for example a bath containing nitric acid and ammonium bi-fluoride, with a pH preferably below 2.

In one embodiment, the process may comprise a step of immersing the metal core in a heated acid bath with the application of ultrasound to clean it.

In one embodiment, the density of the bath is in a range between 1.5 g/cm³ and 2 g/cm³, preferably around 1.7 g/cm³.

In one embodiment, the acid bath treatment temperature is between 70° C. and 120° C.

In one embodiment, the acid bath additionally comprises dissolved aluminum at a concentration of between 20 and 50 g/l, preferably between 25 and 45 g/l.

Another aspect of the invention relates to a waveguide device comprising a metal core with side walls having external and internal surfaces. The internal surfaces define a waveguide channel. The thickness of said side walls is less than 0.3 mm, or even less than 0.2 mm.

### BRIEF DESCRIPTION OF FIGURES

Examples of implementation of the invention are shown in the description illustrated by the appended figures in which:

FIG. 1 illustrates a perspective view of a waveguide device with an internal opening or channel, obtained by an SLM process according to one embodiment;

FIG. 2 shows a view similar to FIG. 1 after a polishing step according to one embodiment;

FIG. 3 illustrates a schematic view of a portion of a waveguide device immersed in a brightening bath to level the microscopic surface roughness of aluminum.

### EXAMPLE(S) OF EMBODIMENT OF THE INVENTION

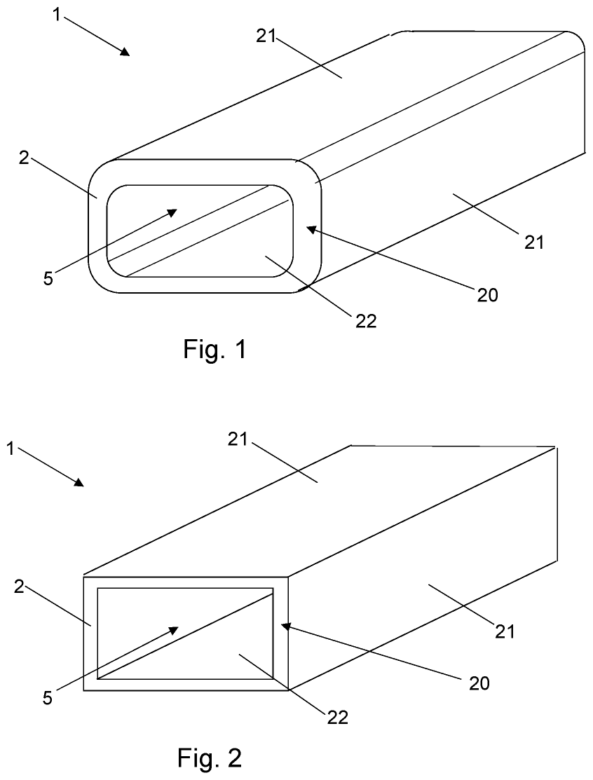

The waveguide device 1 shown in FIGS. 1 and 2 has a metal core 2, for example made of aluminum, titanium, steel, invar or an alloy of these metals.

The core 2 is manufactured by additive manufacturing, preferably by stereolithography, selective laser melting, selective laser sintering (SLS), binder jetting or direct energy deposition (DED). The thickness of the core's walls is at least 0.5 mm, for example.

The shape of the core can be determined by a computer file stored on a computer data medium.

This core 2 delimits an internal opening 5 forming a channel for wave guidance. The core 2 therefore has an internal surface 22 and an external surface 21 defining the internal opening 5, which is, for example, oblong in cross-section.

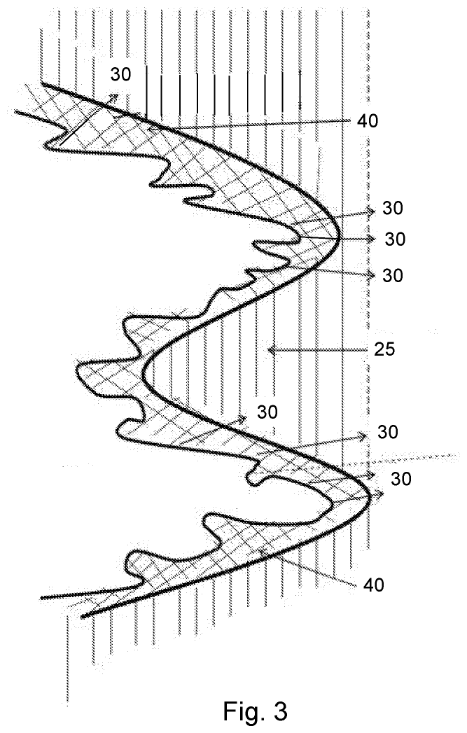

A chemical polishing bath 25 works by leveling the microscopic surface roughness of the material, for example aluminum 30, used to form the core. Polishing is a process that reduces the roughness Ra of the material, enabling it to better reflect light (specularity). This is achieved by levelling the peaks and valleys (or hollows) on the surface of the material, as shown in FIG. 3. Polishing is carried out by soaking the parts in a bath, under constant agitation.

Material roughness Ra or average roughness or arithmetic mean roughness refers to the average distance between peaks and troughs in the material at the scale of the particles (or grains) used for additive manufacturing.

It is known to use chemical or electrochemical polishing steps to reduce the roughness of the material. Surprisingly, the polishing step of the present invention aims, in addition to improving the specularity of the material, to reduce the wall thickness of the waveguide device. Such a reduction in wall thickness is desirable primarily because it enables the weight of the device to be significantly reduced.

In order to significantly reduce the weight of the waveguide device, the thickness of the device's side walls must be reduced by polishing to an ablation thickness equal to at least twice the roughness of the material before the polishing step. The Ra roughness before polishing varies according to the material used for additive manufacturing of the metal core, but is generally between 0.05 μm and 20 μm for the materials considered in the manufacture of the device, for example aluminum, titanium or steel or invar.

In a particular embodiment, this ablation thickness is equal to at least 0.02 mm. Preferably, the ablation thickness is at least 0.05 mm.

Although the thickness of the side walls of the metal core can be greater, it is typically less than 0.5 mm after polishing in order to reduce the weight of the device. Thus, the ablation thickness represents a substantial proportion of the pre-polishing wall thickness.

In one embodiment, the ablation thickness is greater than the thickness of the additive print layers. The thickness of an additive printing layer can vary according to the printing techniques used and the type of part manufactured, but is generally between 0.03 mm and 0.06 mm.

In an embodiment in which printing is carried out by laser melting on a powder bed (SLM), the ablation thickness is greater than 1.5 times the grain size of the powder used. These grains have a diameter of between 0.01 mm and 0.065 mm. Thus, the ablation thickness is between 0.015 mm and 0.098 mm.

More precisely, the particle size distribution is usually between 0.01 mm and 0.065 mm, with a D10 factor, i.e. a maximum of 10% of the grains in the powder batch are smaller than 0.01 mm. Generally speaking, the ablation thickness is at least equal to the D10 factor of the powder batch used for manufacture.

When printing by powder bed fusion, the thickness of the laser spot used to fuse the powder can be between 0.03 mm and 0.1 mm. In this case, the ablation thickness is between 0.02 mm and 0.06 mm.

The bath can be constituted of a mix of 2 acids. Additives ensure uniform surface polishing in terms of roughness and thickness. For perfect smoothing of the aluminum surface, the chemical attack must be faster on the peaks than in the valleys. When aluminum is immersed in a bath of the 2 acids mentioned above, the sulfuric acid reacts with the aluminum to form a thin film of aluminum oxide 40. This film is simultaneously dissolved by orthophosphoric acid. These reactions occur more rapidly at the peaks than at the valleys, because the bath is highly viscous and there is less fluid movement and agitation in the valleys than at the peaks.

The main parameters of the polishing bath are as follows: Bath consisting of two acids (e.g. orthophosphoric and sulfuric); Bath density: approx. 1.7 g/cm³; Treatment temperatures: 80-110° C.; Soaking time: 15 sec to 10 min; Alu concentration dissolved in the bath (for better start-up and good chemical reactivity)=25 to 45 g/l.

In a further embodiment, polishing can be performed using a basic mix, for example for satin finishing. The process involves immersing the semi-finished waveguide in a solution in the presence of salts of organic and inorganic acids, alkalis and polyfunctional organic hydroxyl compounds. The solution may comprise, for example:
Caustic solution: 70-90 g/l
Satin-finish active ingredient: 5-10 g/l
Dissolved aluminium: 10 g/l
   The pH of the solution is preferably above 11.5.

In the case of an aluminum or aluminum alloy waveguide, the part thus satin-finished with the previous bath can be immersed in a deoxidation bath, in order to remove the oxidized residues on the surface of the parts after satin-finishing, and to eliminate the aluminum oxide layer on the surface of the parts. The deoxidation bath can be an acid bath, for example one containing nitric acid, with a pH preferably below 2.

The part thus satin-finished can also be bleached by immersion in an acid bath, for example one containing nitric acid and ammonium bi-fluoride, with a pH preferably below 2. This bleaching can in particular be applied to an aluminum or aluminum alloy waveguide.

The part thus satin-finished can also be immersed in an acid bath, for example 10% concentrated, with a pH below 3, with ultrasound applied to clean it. In one mode of operation, the parts can be immersed in a solution with a temperature of 60 to 65° C., with ultrasound applied for a period of between 2 and 30 minutes, followed by a sequence of 30 min to 1 h00 of soaking without ultrasound, with the temperature maintained at 60° C. These sequences must be repeated 5 times to achieve a good cleaning result. After each ultrasonic sequence, the acid solution is removed and replaced by a fresh solution, enabling effective chemical and ultrasonic activity.

The bath therefore makes it possible to reduce the thickness of the walls 20 of the core 2 so that this thickness between the external surfaces 21 of the core 2 and the internal surfaces of the core 2 defining the internal opening (channel) 5 is reduced to 0.3 mm, or even less than 0.2 mm after the chemical polishing step.

This has the advantage of reducing the weight of waveguide devices.

The invention also relates to a waveguide device obtained according to one of the above embodiments and comprising a metal core 2 comprising side walls 20 having external surfaces 21 and internal surfaces 22, the internal surfaces 22 defining an internal waveguide opening 5, wherein the thickness of said side walls 20 is less than 0.3 mm, or even less than 0.2 mm.

What is claimed is:

1. A manufacturing process of a waveguide device comprising a step of producing, by additive manufacturing, a semi-finished metal core comprising side walls having external and internal surfaces, the internal surfaces defining an internal waveguide opening, wherein the manufacturing process further comprises a step of chemically polishing the metal core to reduce a thickness of said side walls by an ablation thickness equal to at least twice a roughness of the metal core prior to polishing, to obtain the waveguide device.

2. Manufacturing process according to claim 1, wherein said ablation thickness is equal to at least 0.02 mm.

3. Manufacturing process according to claim 1, wherein said ablation thickness is equal to at least 0.05 mm.

4. Manufacturing process according to claim 1, wherein said ablation thickness is greater than an additive printing layer thickness.

5. Manufacturing process according to claim 1, wherein the metal core is produced by additive manufacturing using laser melting on a powder bed, so as to obtain the semi-finished metal core, said ablation thickness being equal to at least 1.5 times a powder grain size of said powder bed.

6. Manufacturing process according to claim 1, wherein the metal core is produced by additive manufacturing using laser melting on a powder bed so as to obtain the semi-finished metal core, a laser spot having a diameter of between 0.03 mm and 0.1 mm and said ablation thickness of between 0.02 mm and 0.06 mm.

7. Manufacturing process according to claim 1, wherein the metal core is produced by additive manufacturing using laser melting on a powder bed so as to obtain the semi-finished metal core, wherein the thickness of said side walls is equal to or less than 0.5 mm.

8. Manufacturing process according to claim 1, wherein the internal waveguide opening of the semi-finished metal core has an oblong, pentagonal, hexagonal, ovoid or circular cross-section.

9. Manufacturing process according to claim 1, wherein the thickness of said side walls is less than 0.3 mm after the chemical polishing step.

10. Manufacturing process according to claim 1, further comprising a step of generating a digital model of the metal core, said digital model being calculated so as to optimize the shape of the semi-finished metal core as a function of a thickness to be removed by chemical polishing.

11. Manufacturing process according to claim 1, wherein the chemical polishing step comprises immersion of the semi-finished metal core in an acid bath.

12. Manufacturing process according to claim 11, said acid bath comprising a mix of two acids.

13. Manufacturing process according to claim 12, said acid bath comprising orthophosphoric acid and sulfuric acid.

14. Manufacturing process according to claim 11, wherein the density of the bath lies in a range between 1.5 g/cm³ and 2 g/cm³, preferably around 1.7 g/cm³.

15. Manufacturing process according to claim 11, wherein a treatment temperature of the acid bath is between 70° C. and 120° C.

16. Manufacturing process according to claim 11, wherein the acid bath additionally comprises dissolved aluminum at a concentration of between 20 and 50 g/l.

17. Manufacturing process according to claim 1, wherein the chemical polishing step comprises immersion of the semi-finished metal core in a basic bath.

18. Manufacturing process according to claim 17, said basic bath comprising a caustic solution and having a pH greater than 11.5.

19. Manufacturing process according to claim 17, comprising a step of immersing the metal core in an acidic deoxidation bath following immersion in said basic bath, so as to remove oxidized residues from the surface of parts of the metal core.

20. Manufacturing process according to claim 17, comprising a step of immersing the metal core in an acid bath containing nitric acid and ammonium bi-fluoride, with a pH below 2.

21. Manufacturing process according to claim 11, comprising a step of immersing the metal core in a heated acid bath with the application of ultrasound to clean it.

22. A waveguide device obtained according to claim 1, comprising a metal core including side walls with external and internal surfaces, the internal surfaces defining an internal waveguide opening, wherein the thickness of said side walls is less than 0.3 mm.
